(19) United States
(12) Patent Application Publication
(10) Pub. No.: US 2021/0161224 A1
(43) Pub. Date: Jun. 3, 2021

(54) SPORTS FACE MASK

(71) Applicant: Jung-Tang Kung, Taoyuan City (TW)

(72) Inventor: Jung-Tang Kung, Taoyuan City (TW)

(21) Appl. No.: 17/105,580

(22) Filed: Nov. 26, 2020

(30) Foreign Application Priority Data
Nov. 29, 2019 (TW) 108215894
Nov. 29, 2019 (TW) 108215895

(51) Int. Cl. A41D 13/11; A62B 23/02

(52) U.S. Cl. CPC A41D 13/1161; A41D 2600/10; A62B 23/025; A41D 13/1138

(57) ABSTRACT

A sports face mask with an inhalation zone and an exhalation zone, both of which are separated from each other, comprises: an outer layer body used to filter air and create a large-sized inhalation zone inside as an inhalation space for nose breathing; an exhalation duct located inside the outer layer body and forming an exhalation zone inside as a space in which a mask user's breaths from the mouth are exhaled; a fixed support located between the outer layer body and the exhalation duct for fastening the exhalation duct on the outer layer body. The exhalation duct comprises an air inlet and an air outlet; the sports face mask is equipped with a replaceable filtering layer inside, which is removable, cleanable or replaceable for a clean sports face mask, and wearing portions used to fix the sports face mask on a mask user's mouth and nose and located at both sides of the outer layer body, respectively.

### BACKGROUND OF THE INVENTION

### Field of the Invention

The present application relates to a sports face mask, particularly a face mask with an exhalation zone and an inhalation zone, both of which are separated from each other, for a user doing exercises.

### Description of the Prior Art

Exercising that is a topic getting sustained attention of people helps boost a sports enthusiast's cardio-pulmonary function, muscle building, muscle flexibility, metabolism, strong bones, thermal energy consumption, less adipose accumulation, relaxation of body and mind, stress release, body immunity, etc.

In a society full of more and more serious pollutions such as various sources of pollutions and fine particulate matter (PM2.5) in air, how to filter airborne hazardous substances and supply adequate oxygen to persons doing exercises has been a critical issue in the art.

In general, a face mask providing a mask user with ambient air from which hazardous substances have been filtered features its structure covering the user's mouth and nose simultaneously. However, plenty of carbon dioxide in breaths exhaled by a mask user and trapped in a face mask stagnates inside the mask's inner space easily but is difficultly released; then, carbon dioxide trapped in a face mask is mixed with ambient air inhaled by the user, who is taking one more breath which is significantly short of fresh air and sufficient oxygen needed by the user, and the issue is worsened for a person doing the aerobic exercise.

In addition to body posture, warm-up, muscle stretching and nutritional supplementation, a person has to take care of his (her) breaths during workout for supply of oxygen necessary to metabolism inside the human body and discharge of carbon dioxide. In particular, sufficient oxygen should be supplied to a sportsperson through his (her) breaths in the aerobic exercise during which a lot of oxygen is consumed by muscles.

A sportsperson who inhales sufficient oxygen is impervious to sport injuries, supplied with energy for cells and benefited in accelerated fat combustion. However, the loss outweighs the gain when a sportsperson who wears a face mask with which airborne hazardous substances are blocked out has no access to sufficient oxygen but suffer from healthy damages.

Accordingly, how to filter airborne hazardous substances during exercises and supply sufficient oxygen to a sportsperson who doesn't inhale the breaths again but makes use of a smooth exhalation duct deserves to be settled by persons skilled in the art.

Furthermore, moistures in breaths are usually trapped inside an ordinary face mask. In this regard, how to promote comfort and smooth breathing of a mask user who is taking a breath but prevent moistures from being remained in a face mask and exasperating humidity is an issue to be settled.

In virtue of drawbacks of the prior art, the patent applicant creates a sports face mask in the present application after long-term research and tests.

### SUMMARY OF THE INVENTION

To settle current technical drawbacks in the prior art, the patent applicant provides a sportsperson with a sports face mask through which various sources of pollutions and fine particulate matter (PM2.5) in air are filtered, sufficient oxygen is supplied to a mask user from adequate inhalation space during exercises, and breaths are exhausted smoothly.

The present disclosure provides a sports face mask with an exhalation zone and an inhalation zone, both of which are separated from each other, such that least carbon dioxide exhaled by a mask user stagnates in a face mask and exhaled breaths are not inhaled by the mask user again.

The present disclosure provides a sports face mask with a smooth exhalation duct through which a mask user is able to breathe deeply without residual moistures inside a face mask.

The present disclosure provides a sports face mask featuring inhalation and exhalation separated for respiratory regulations during exercises.

To this end, a sports face mask in the present disclosure features an exhalation zone and an inhalation zone, both of which are separated from each other, and comprises an outer layer body, a fixed support and an exhalation duct: the outer layer body made of breathable materials is used to filter air and create a large-sized inhalation zone inside as an adequate inhalation space for nose breathing and equipped with separate wearing portions at both sides of the outer layer body for fixing the sports face mask on a mask user's face and has a first opening underneath; the fixed support between the outer layer body and the exhalation duct is used to fasten the exhalation duct on the outer layer body; the exhalation duct located inside the outer layer body and made of an airtight material forms an exhalation zone inside as a space in which a mask user's breaths from the mouth are exhaled and comprises an air inlet, which links and closely fits a mask user's mouth for separation of the inhalation zone and the exhalation zone, and an air outlet, which is designed at the juncture of the exhalation duct and the outer layer body and links the first opening for discharge of exhaled breaths from a mask user's mouth to outside of the sports face mask.

In the sports face mask, the fixed support comprises a first support structure and a second support structure: the first support structure is made as a frame with which the outer fringes of the outer layer body are supported; the second support structure allows its center to support the front end of the outer layer body and link the first support structure with a bar-type structure which features an arc shape fitting the outer layer body and comprises a left bar-type structure, a right bar-type structure and a lower bar-type structure with a second opening for fastening the air outlet. The fixed support is fixed on or detachable from the connected outer layer body; the exhalation duct is fixed on or detachable from the connected fixed support.

In the sports face mask, the top tilts down from one side near a mask user's face to the other side away from the user's face for no obstruction of the user's line of view; the top features a length ranging from 3 cm to 10 cm for development of the large-sized inhalation zone from which a mask user doing exercises inhale plenty of air smoothly; the exhalation duct tilts down from the air inlet to the air outlet for smooth guidance and discharge of exhaled breaths from the air outlet.

In the sports face mask, the outer layer body is equipped with a replaceable filtering layer inside which is removable, cleanable and replaceable for a clean sports face mask.

In the sports face mask, a wearing portion comprises an elastic band, an ear strap, a head strap or other elastic components; the wearing portion further comprises a fastening component on which a hook, a buckle or a hook-and-loop fastener is installed.

In the sports face mask, the air outlet links a filter through which breaths exhaled from a face mask user's mouth are filtered.

In the sports face mask, the filter features its shell made of an airtight material and through holes designed at the bottom side of the filter shell for guidance of exhaled breaths into the filter from the air outlet and discharge of exhaled breaths from the through holes wherein the filter shell is opened for replacement of a filter cotton inside the filter.

In the sports face mask, the exhalation duct features its length ranging from 6 cm to 8 cm; the air inlet features its width ranging from 6 cm to 8 cm and height ranging from 4 cm to 6 cm; the air outlet features its diameter ranging from 0.7 cm to 2 cm; the filter features its width ranging from 5 cm to 8 cm, depth ranging from 2.5 cm to 5 cm and height ranging from 0.5 cm to 1.5 cm.

### BRIEF DESCRIPTION OF THE DRAWINGS

FIG. 1 is a sectional view of a sports face mask;

FIG. 2 is a schematic sectional view of a sports face mask in use;

FIG. 3 is an exploded view of a sports face mask;

FIG. 4 is a perspective view of a filter to be mounted in a sports face mask;

FIG. 5 is a perspective view of a sports face mask in an embodiment; and

FIG. 6 is a perspective view of a sports face mask in another embodiment.

### DETAILED DESCRIPTION OF THE PREFERRED EMBODIMENT

The invention is exemplified by the following embodiments but is not limited by thereof.

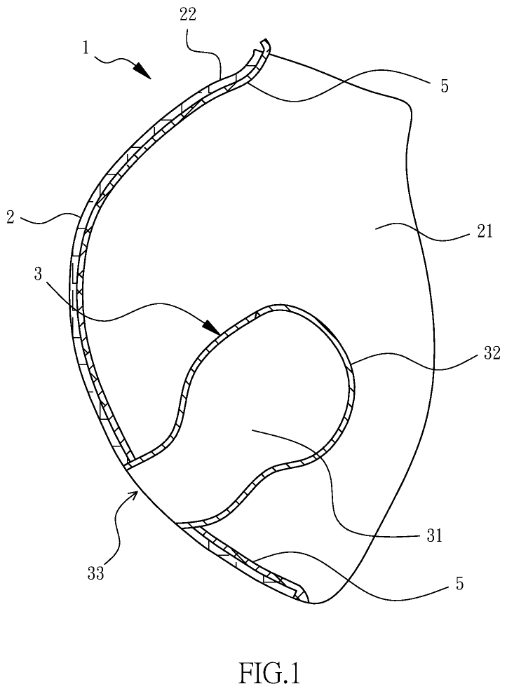

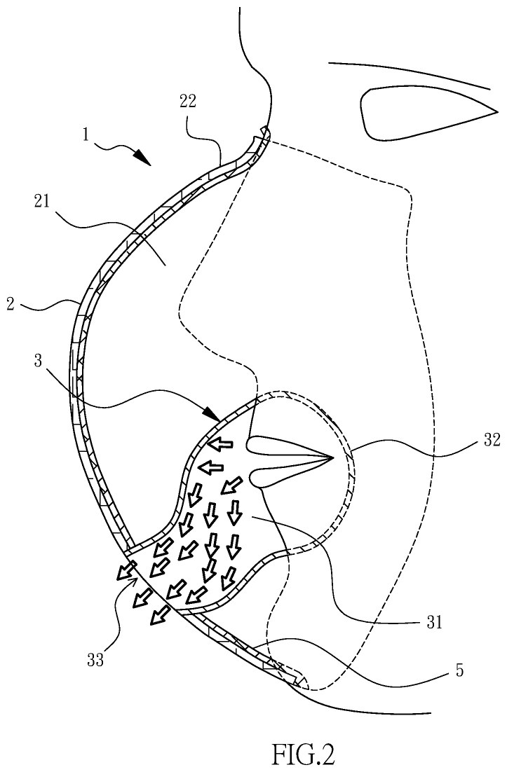

Referring to FIGS. 1 and 2, which illustrate a sports face mask with an exhalation zone and an inhalation zone, both of which are separated from each other, wherein a mask body 1 comprises following components in structure:

an outer layer body 2 that is made of breathable materials and used to filter air and create a large-sized inhalation zone 21 inside as an adequate inhalation space for nose breathing and has a top 22 above as well as a first opening 23 underneath; and

an exhalation duct 3 that is designed inside the outer layer body 2, made of airtight materials for development of the exhalation zone 31 within, and prepared for creation of a space in which a mask user's breaths from the mouth are exhaled and comprises:

an air inlet 32 that is used to connect with and closely fit a mask user's mouth for separation between the inhalation zone 21 and the exhalation zone 31; and

an air outlet 33 that is designed at the junction of the exhalation duct 3 and the outer layer body 2 and connects with the first opening 23 through which a mask user's breaths from the user's mouth are exhaled.

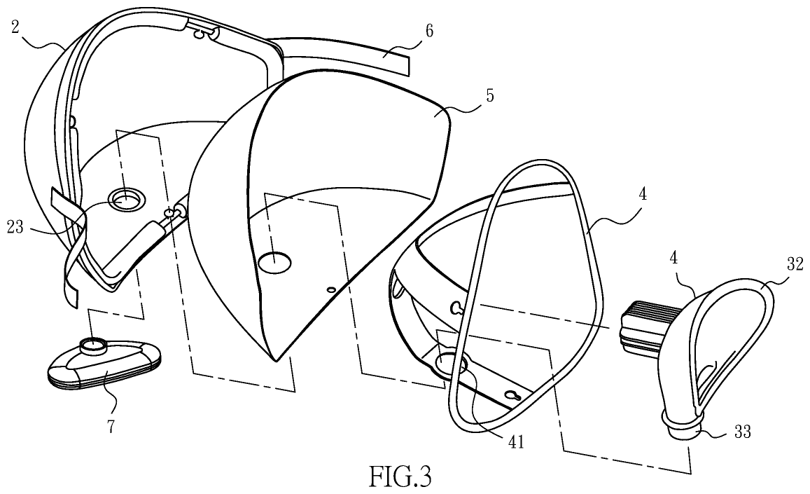

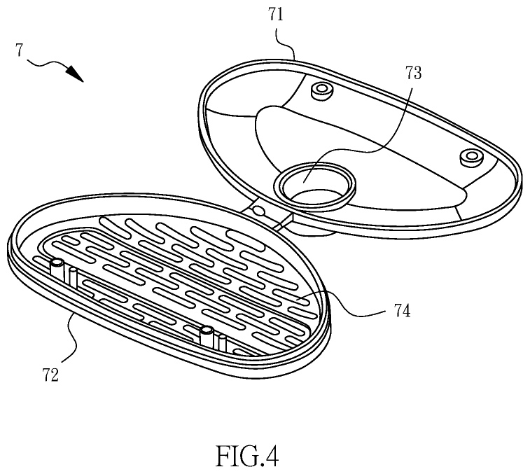

Referring to FIGS. 3 and 4, which illustrate a sports face mask in the present application further comprises a fixed support 4; the fixed support 4, which is located between the outer layer body 2 and the exhalation duct 3, is used to fix the exhalation duct 3 at the outer layer body 2; the fixed support 4 comprises a first support structure and a second support structure; the first support structure is made as a frame with which the outer fringes of the outer layer body 2 are supported; the second support structure allows its center to support the front end of the outer layer body 2 and link the first support structure with a bar-type structure which features an arc shape fitting the outer layer body 2 and comprises a left bar-type structure, a right bar-type structure and a lower bar-type structure with a second opening 41 for fastening the air outlet 33. The fixed support 4 is fixed on or detachable from the connected outer layer body 2; the exhalation duct 3 is fixed on or detachable from the connected fixed support 4.

The exhalation duct 3 is made of silicone or plastic; preferably, the exhalation duct 3 features the air inlet 32 made of silicone and the air outlet 33 made of plastic. The fixed support 4 is made of metal, silicone, or plastic; preferably, the fixed support 4 is manufactured with the combination of a steel ring and silicone. The filter 7 is made of silicone or plastic; preferably, the filter 7 is made of plastic and links the air outlet 33 at a juncture made of silicone.

The outer layer body 2 is equipped with a replaceable filtering layer 5 inside such that the replaceable filtering layer 5 is removable, cleanable and replaceable for a clean sports face mask.

The air outlet 33 links a filter 7 through which a mask user's breaths are filtered. The filter 7 features its shell made of an airtight material, a third opening 73 designed at the top side 71 of the filter shell and linking the air outlet 33 of the exhalation duct 3, and a plurality of through holes 74 designed at the bottom side 72 of the filter shell for guidance of exhaled breaths into the filter 7 from the air outlet 33 and discharge of exhaled breaths from the through holes 74 wherein the through holes 74 have a total area greater than or equal to the area of the air outlet 33 for smooth discharge of exhaled breaths and the filter shell is opened for replacement of a filter cotton inside the filter 7.

The exhalation duct features its length ranging from 6 cm to 8 cm; preferably, the exhalation duct has a length ranging from 6.4 cm to 7.4 cm. The air inlet features its width ranging from 6 cm to 8 cm and height ranging from 4 cm to 6 cm; preferably, the air inlet has a width ranging from 6.7 cm to 7.6 cm and a height ranging from 4.2 cm to 5 cm. The air outlet features its diameter ranging from 0.7 cm to 2 cm; preferably, the air outlet has a diameter ranging from 0.9 cm to 1.4 cm. The filter features its width ranging from 5 cm to 8 cm, depth ranging from 2.5 cm to 5 cm, and height ranging from 0.5 cm to 1.5 cm; preferably, the filter has a width ranging from 6.0 cm to 7.2 cm, a depth ranging from 3.3 cm to 4.3 cm, and a height ranging from 0.6 cm to 1.0 cm.

In the structure of a sports face mask, the top 22 tilts down from one side near a mask user's face to the other side away from the user's face for no obstruction of the user's line of view; moreover, the top 22 features a length ranging from 3 cm to 10 cm, preferably from 4.5 cm to 7 cm, for development of the large-sized inhalation zone 21 from which a mask user doing exercises inhale plenty of air smoothly for adequate supply of oxygen and no respiratory resistance.

The exhalation duct 3 tilts down from the air inlet 32 to the air outlet 33 in structure for smooth guidance and discharge of exhaled breaths from the air outlet 33.

For a sports face mask in an embodiment, the outer layer body 2 is equipped with a replaceable filtering layer 5 inside which is removable, cleanable and replaceable for a clean sports face mask.

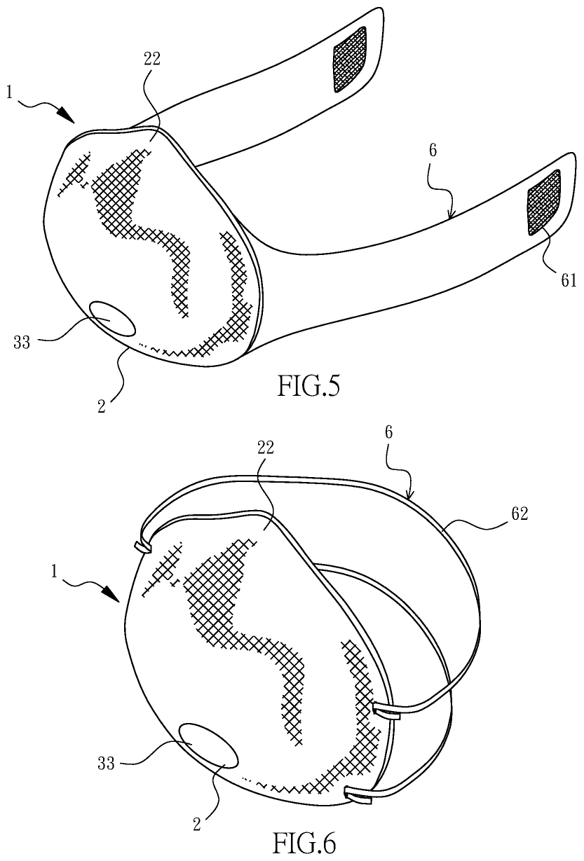

Referring to FIG. 5, which illustrates a sports face mask in an embodiment is equipped with wearing portions 6 used to fix the sports face mask on a mask user's face and located at both sides of the outer layer body 2, respectively; in the sports face mask, a wearing portion 6 comprises an elastic band, an ear strap, a head strap or other elastic components.

For a sports face mask in an embodiment, the wearing portion 6 comprises a fastening component 61 on which a hook, a buckle or a hook-and-loop fastener is installed. To use a sports face mask, a user pulls the wearing portions 6 at both sides of the mask body 1 backward such that the wearing portions 6 rely on the fastening components 61 to join together at the back of the user's head and the sports face mask covers the user's nose and mouth. Furthermore, a wearing portion 6 features its length which is adjusted to match a mask user's head size for adjustable degree of tightness in use.

Referring to FIG. 6, which illustrates the wearing portion 6 of a sports face mask in another embodiment is a head strap 62 to be fastened at the back of a mask user's head and easily ripped off by a mask user who intends to wear or remove the sports face mask.

The embodiments described above are merely for explaining the technical ideas and characteristics of the present invention, and the purpose thereof is to enable those skilled in the art to understand the contents of the present invention and implement them accordingly, and they are not intended to limit the scope of the claims of the present invention, that is, any equivalent changes or modifications made according to the spirit of the disclosure should still be covered by the claims of the present invention.

What is claimed is:

1. A sports face mask, comprising an outer layer body, a fixed support and an exhalation duct:
the outer layer body made of breathable materials is used to filter air and create a large-sized inhalation zone inside as an adequate inhalation space for nose breathing and equipped with separate wearing portions at both sides of the outer layer body for fixing the sports face mask on a mask user's face and has a first opening underneath;
the fixed support between the outer layer body and the exhalation duct is used to fasten the exhalation duct on the outer layer body;
the exhalation duct located inside the outer layer body and made of an airtight material forms an exhalation zone inside as a space in which a mask user's breaths from the mouth are exhaled and comprises: an air inlet, which links and closely fits a mask user's mouth for separation of the inhalation zone and the exhalation zone; an air outlet, which is designed at the juncture of the exhalation duct and the outer layer body and links the first opening for discharge of exhaled breaths from a mask user's mouth to outside of the sports face mask.

2. The sports face mask as claimed in claim 1, wherein the fixed support comprises a first support structure and a second support structure: the first support structure is made as a frame with which the outer fringes of the outer layer body are supported; the second support structure allows its center to support the front end of the outer layer body and link the first support structure with a bar-type structure which features an arc shape fitting the outer layer body and comprises a left bar-type structure, a right bar-type structure and a lower bar-type structure with a second opening for fastening the air outlet.

3. The sports face mask as claimed in claim 1, wherein the fixed support is fixed on or detachable from the connected outer layer body and the exhalation duct is fixed on or detachable from the connected fixed support.

4. The sports face mask as claimed in claim 1, wherein the outer layer body covers a mask user's face from the nose bridge to the chin and has a top, which tilts down from one side near a mask user's face to the other side away from the user's face for no obstruction of the user's line of view and features a length ranging from 3 cm to 10 cm for development of the large-sized inhalation zone as an adequate inhalation space of a mask user doing exercises; the exhalation duct tilts down from the air inlet to the air outlet for smooth guidance and discharge of exhaled breaths from the air outlet.

5. The sports face mask as claimed in claim 1, wherein the outer layer body is equipped with a replaceable filtering layer inside which is removable, cleanable and replaceable for a clean sports face mask.

6. The sports face mask as claimed in claim 1, wherein the wearing portion comprises an elastic band, an ear strap, a head strap or other elastic components and further comprises a fastening component on which a hook, a buckle or a hook-and-loop fastener is installed.

7. The sports face mask as claimed in claim 1, wherein the air outlet links a filter through which exhaled breaths from a face mask user's mouth are filtered.

8. The sports face mask as claimed in claim 7, wherein the filter features its shell made of an airtight material, a third opening designed at the top side of the filter shell and linking the air outlet of the exhalation duct, and a plurality of through holes designed at the bottom side of the filter shell for guidance of exhaled breaths into the filter from the air outlet and discharge of exhaled breaths from the through holes, the through holes have a total area greater than or equal to the area of the air outlet for smooth discharge of exhaled breaths, and the filter shell is opened for replacement of a filter cotton inside the filter.

9. The sports face mask as claimed in claim 1, wherein the exhalation duct features its length ranging from 6 cm to 8 cm; the air inlet features its width ranging from 6 cm to 8 cm and height ranging from 4 cm to 6 cm; the air outlet features its diameter ranging from 0.7 cm to 2 cm; the filter features its width ranging from 5 cm to 8 cm, depth ranging from 2.5 cm to 5 cm and height ranging from 0.5 cm to 1.5 cm.
